(19) United States
(12) Patent Application Publication
(10) Pub. No.: US 2003/0106248 A1
(43) Pub. Date: Jun. 12, 2003

(54) Revolving decoration

(76) Inventor: Paul Chang, Hsi-Chih City (TW)

Correspondence Address: RABIN & BERDO, P.C., Suite 500, 1101 14th Street, N.W., Washington, DC, 20005, US

(21) Appl. No.: 10/004,425

(22) Filed: Dec. 6, 2001

(51) Int. Cl. G09F 19/08

(52) U.S. Cl. 40/554; 40/440

(57) ABSTRACT

A revolving decoration comprising a curve shade, a wave shape formed on the bottom circumference of the curve shade, a finial on top center of the curve shade, several curve blades installed surrounding the curve shade and centered around the finial, an air-conducting hole between every two curve blade, an top hole is beneath the finial. A heat source, light bulb or candle, beneath the present invention can generate hot air passes through the air-conducting holes and drives the curve blade to rotate.

### BACKGROUND OF THE INVENTION

I. Field of the Invention

This invention relates generally to a revolving decoration and, more specifically, to a revolving decoration that can rotate without electrical power, and offer novelty, loveliness and energy saving capability.

II. Description of the Prior Art

Heretofore, it is known that general decorators have a lovely ornament and several strings to hang other small decorating elements for better viewing effect. However, most of them are still and not lively enough, therefore as time goes by, those decorators might lose attraction and novelty. Other moving decorators, except aeolian bells moved by wind, are equipped with electrical power system such as extra batteries, motors, wires and other components. They also have to be assembled with extra time and manpower, those decorators eventually consume and waste energy.

### SUMMARY OF THE INVENTION

It is therefore a primary object of the invention to provide a revolving decoration comprising a curve shade, a wave shape formed on the bottom circumference of the curve shade, a finial on top center of the curve shade, several curve blades installed surrounding the curve shade and centered around the finial, an air-conducting hole between every two curve blade, an top hole is beneath the finial. A heat source, light bulb or candle, beneath the present invention can generate hot air passes through the air-conducting holes and drives the curve blade to rotate.

It is a further objective of this invention to provide a revolving decoration in which the bottom circumference of the curve shade is formed in wave shape, several strings each has a decorating plate or 3D ornament attached at the end, that makes several decorating plate surrounding the curve shade. The decorating plate will also rotate and rise along with the curve shade to have a magnificent scene.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a cross-sectional of the present invention;

FIG. 3 is a perspective view of an embodiment of the present invention;

FIG. 4 is another perspective view of an embodiment of the present invention.

### DESCRIPTION OF THE PREFERRED EMBODIMENT

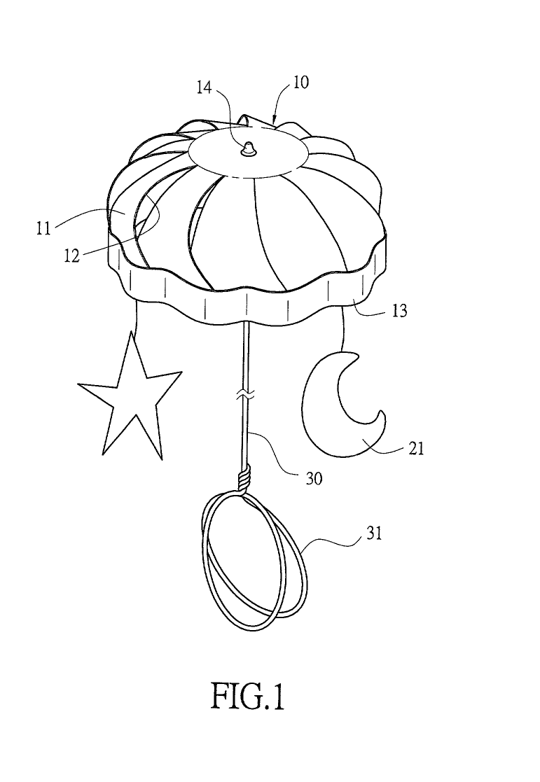

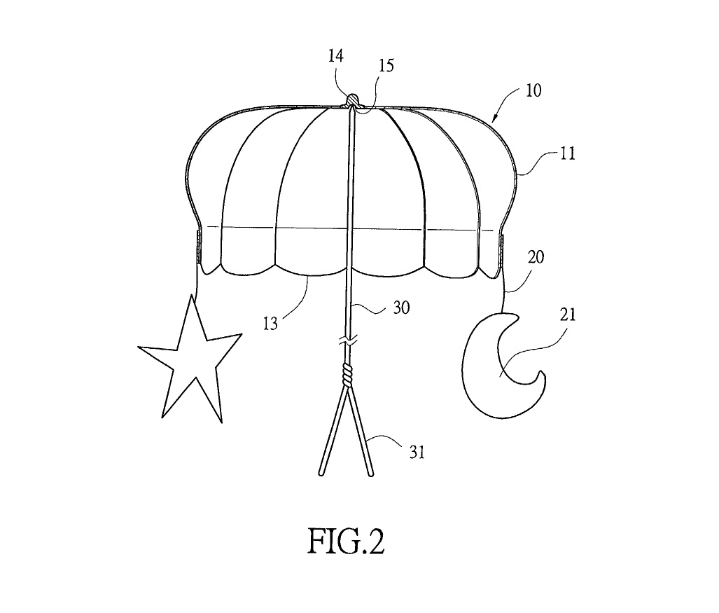

The present invention applies hot air flow to drive the ornament rotate automatically. Referring to FIG. 1 and FIG. 2, the present invention is composed of a curve shade 10, which is made of thin, light and fireproof materials (copper and aluminum for example). A wave shape 13 is formed on the bottom circumference of the curve shade 10, a finial 14 is on top center of the curve shade 10. A tern 30 is attached to the top hole. Several curve blade 11 are installed surrounding the curve shade 10 and centered around the finial 14, an air-conducting hole 12 is between every two curve blade 11; an top hole 15 is beneath the finial 14.

Several string 20 each has a decorating plate 21 or 3D ornament attached at the end, the other end of the string 20 is fixed firmly at the proper location of the bottom of the curve shade 10, that makes several decorating plate 21 are surrounding the curve shade 10.

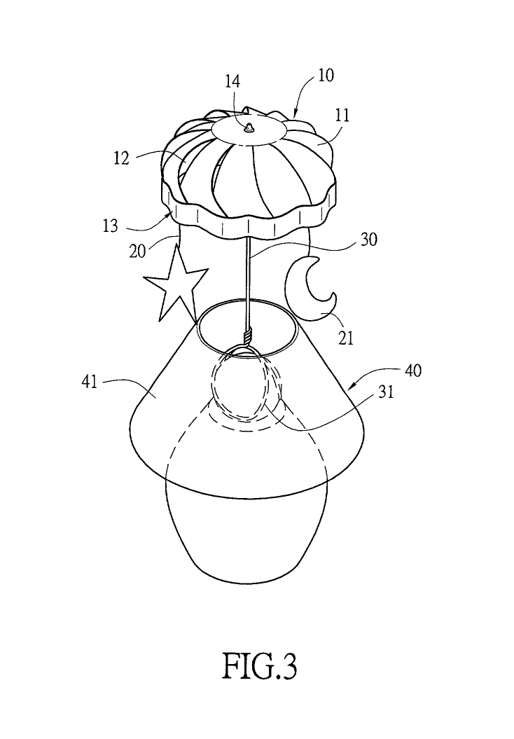

Referring to FIG. 1 and FIG. 2, the top of a stem 30 is attached to the top hole 15 of the curve shade 10, a sustaining assembly 31 is on the bottom of the stem 30. Referring to FIG. 1 and FIG. 3, one example of the present invention. Two circles stretched with a small angle form the sustaining assembly 31 of the stem 30; the sustaining assembly 31 can be fixed above the heat source 60 (a light bulb for example) of a mini lamp 40. The other end of the stem 30 is stretch out from top of the lampshade 41, and has the stem 30 attached inside the top hole 15 of the curve shade 10. When the mini lamp 40 is on, the hot air rises above, pushes the curve blade 11 of the curve shade 10 and finally passes through the air-conducting hole 12, therefore the curve shade 10 will rotate around the stem 30.

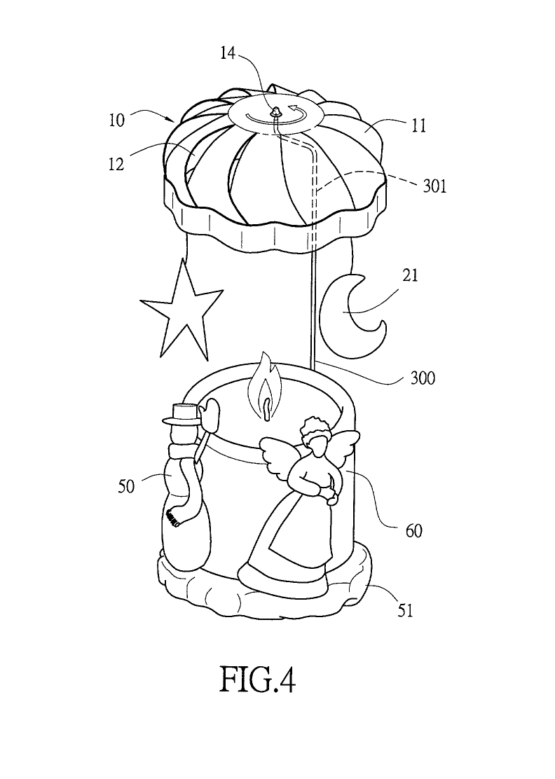

Referring to FIG. 4, another example of the present invention above a candlestick. A heat source 60, the candle is on the base 51 of the candlestick, the base 51 is surround with several ornament 50 to decorate. The bottom of the stem 300 is fixed on the base 51, the other end of the stem 300 is bent to form a bending area 301, the top of the stem 300 is attached beneath the finial 14 of the curve shade 10 to have the curve shade 10 right above the heat source 60. When the heat source 60 is lighted up, the generated hot air can drive the curve shade 10 to rotate, the decorating plate 21 will also rotate and rise along with the curve shade 10 to have a magnificent scene.

While a preferred embodiment of the invention has been shown and described in detail, it will be readily understood and appreciated that numerous omissions, changes and additions may be made without departing from the spirit and scope of the invention.

What is claimed is:

1. A revolving decoration comprising:
a curve shade with several strings each has a decorating plate or 3D ornament attached at the end;
a finial located on top center of said curve shade;
a top hole located beneath said finial;
a stem attached beneath said top hole;
several curve blades installed surrounding said curve shade and centered around said finial;
an air-conducting hole located between every two said curve blades;
a heat source beneath said curve shade to generate hot air passing through said air-conducting holes and drive said curve shade to rotate around said finial.

2. The revolving decoration recited in claim 1, wherein said curve shade is made of thin, light and fireproof materials such as copper and aluminum.

3. The revolving decoration recited in claim 1, wherein said curve shade having wave shape formed on the bottom circumference.

4. The revolving decoration recited in claim 1, wherein bottom of said stem is formed by two circles stretched with a small angle as a sustaining assembly, said sustaining assembly can be fixed above the heat source, the other end of said stem is in sharp end to attach to said top hole of said curve shade.

5. The revolving decoration recited in claim 1, wherein bottom of said stem is fixed on the base of a candlestick, the other end of said stem is bent to form a bending area, the top of said stem is right above the heat source.
